(19) United States
(12) Patent Application Publication
(10) Pub. No.: US 2026/0088576 A1
(43) Pub. Date: Mar. 26, 2026

(54) OVERLOAD PROTECTION WALL SOCKET

(71) Applicant: HANGZHOU DONGCHAN TEMPERATURE CONTROL EQUIPMENT CO., LTD., Hangzhou, Zhejiang (CN)

(72) Inventor: QUN FU, Jiande (CN)

(21) Appl. No.: 17/988,658

(22) PCT Filed: May 8, 2021
(86) PCT No.: PCT/CN2021/110927

§ 371 Date: Jun. 16, 2025

(30) Foreign Application Priority Data
Apr. 22, 2021 (CN) 202110438400.0

(51) Int. Cl. H01R 13/713

(52) U.S. Cl. CPC H01R 13/713

(57) ABSTRACT

An overload protection wall socket is provided, which includes a socket body, a plug interface is arranged on the socket body, the plug interface includes a plurality of first jacks located on a surface of the socket body, and conductive strips matching the first jacks are arranged inside the socket body, the conductive strip is provided with a first pin seat arranged at an opening of the first jack, the socket body is provided with a wire connecting device matching the conductive strip, the wire connecting device and the conductive strip are connected through an overload protection device. The structure of the socket is simple, the processing and installation are convenient, the space is saved; the occurrence of fire is effectively prevented, the fire safety is ensured; the safety is high; the structural stability is good; socket can be easily mounted on the wall.

### CROSS-REFERENCE TO RELATED APPLICATIONS

This application is a National Stage of International Application No. PCT/CN2021/110927, filed Aug. 5, 2021, which claims priority to Chinese Patent Application No. 202110438400.0 filed Apr. 22, 2021. Both of which are hereby incorporated by reference in their entireties.

### TECHNICAL FIELD

The present application relates to the technical field of sockets, in particular to an overload protection wall socket.

### BACKGROUND

Sockets are also known as power socket or switch socket. A socket is a socket into which one or more circuit wirings can be inserted, through which various wirings can be inserted, which facilitates connection with other circuits. Through the connection and disconnection between the line and the copper piece, the connection and disconnection of the circuit are finally achieved.

Most of the traditional sockets only have simple on and off functions, but in the event of electric shock, leakage, short circuit, etc., the load will be overloaded. In most cases, only the main gate can be disconnected. Although this can protect the load, it will lead to collective power loss, which may cause greater economic losses.

### SUMMARY

The present application provides an overload protection wall socket with overload protection function in order to overcome the deficiency of the lack of overload protection function in the prior art.

In order to achieve the above object, the present application adopts the following technical solutions:

An overload protection wall socket, comprising: a socket body, a plug interface is provided on the socket body, and the plug interface comprises a plurality of first jacks located on surface of the socket body, wherein conductive strips matching the first jack are arranged inside the socket body, and the conductive strip is provided with a first pin seat, the first pin seat is arranged at opening of the first jack, and a wire connecting device matching the conductive strip is arranged on the socket body, wherein the wire connecting device and the conductive strip are connected through an overload protection device.

The load plug is inserted at the plug interface, and the pins on the load plug are in contact with the conductive strips and are fixed on the first pin socket; the wire connecting device is connected to the power supply. It has a simple structure and is easy to process and install. In the natural state, the conductive strip and the wire connecting device are connected, and the load can work normally; when the circuit is overloaded, the overload protection device will automatically disconnect the connection between the conductive strip and the wire connecting device to achieve the purpose of overload protection., which effectively prevents the occurrence of fire and ensures fire safety.

Preferably, a cross-sectional shape of the first pin seat is U-shaped, and the first pin seat is fixedly connected to the conductive strip, two side legs of the first pin seat are respectively provided with a flanging, one side of the flanging is fixed on the side leg of the first pin seat and a chamfer is formed therebetween, the other side of the flanging is placed in the first jack, the two flanging are respectively in contact with inner side walls on opposite sides of the first jack, and distance between the two flanging gradually increases from one side to the other. The other side of the two flanging is clamped in the first jack, which realizes the fixing of the pin seat in the first jack, and the pin inserted into the first jack is clamped by the two side legs of the first pin seat, which realizes the fixing and connection of the pin. The installation is easy, and it is convenient for the installation and fixing of the pin seat at one place of the jack and the installation and fixing of the pin on the pin seat.

Preferably, the conductive strip is fixedly connected with top of one of the side legs of the first pin seat, and the flanging is fixed on side wall of the side leg of the first pin seat. The conductive strip, the first pin seat and the flanging are integrally formed, which is convenient for processing.

Preferably, the plug interface further comprises a second jacks located on the surface of the socket body, the second jack is arranged on one side of the first jack, grounding strips matching the second jacks are arranged inside the socket body, the grounding strip is provided with a second pin seat, the second pin seat is arranged at opening of the second jack. The second jack is used to connect the grounding pin on the plug, and the grounding bar is connected to the grounding wire to prevent leakage and high safety.

Preferably, the second pin seat comprises a fixing block fixed on the grounding strip, and mounting plates are fixed on both ends of the fixing block, a front side of the mounting plate is arranged in the second jack, and the two mounting plates are respectively in contact with inner side walls on opposite sides of the second jack, the grounding strip is provided with a grounding strip through hole, a rear side of the mounting plate is arranged in the grounding strip through hole, and the two mounting plates are respectively in contact with inner side walls on opposite sides of the grounding strip through hole, the fixing block is fixed on the left side of the mounting plate, the right side of the mounting plate is provided with an L-shaped block, one of the sides of the L-shaped block is fixed on the right side of the mounting plate, the L-shaped block is arranged at an opening of the ground bar through hole facing the side of the second jack. The fixing block is provided with a clamping slot, the grounding strip is provided with a clamping pin matching the clamping slot, and the fixing block is fixed on the ground strip through the cooperation of the clamping slot and the clamping pin. The front sides of the two mounting plates are clamped in the second jack, which realizes the fixing of the second pin seat in the second jack, and the pins inserted into the second jack are in contact with the mounting plate to realize the conduction of the pins. The rear sides of the two mounting plates are clamped in the grounding strip through hole, so that the second pin seat is fixed in the grounding strip through hole. Through the L-shaped block, the stability of the mounting plate arranged in the grounding strip through hole is improved, and the structural stability is good.

Preferably, the socket body comprises a socket panel, the first jack and the second jack are arranged on the socket panel, a socket protective shell is arranged on the socket panel, and a side of the socket protective shell close to the socket panel is provided with conductive strip mounting slots matching the conductive strips, grounding strip mounting slots matching the grounding strips, wherein the conductive strip and the grounding strip are respectively arranged in the conductive strip mounting slot and the grounding strip mounting slot, the grounding strip penetrates the grounding strip mounting slot and is placed outside the socket protective shell, the grounding strip is provided with a mounting hole and a wiring hole, the mounting hole and the wiring hole are arranged outside the socket protective shell. The socket panel and socket protective shell are connected by screw thread, which makes the installation convenient and stable. The socket protective shell plays the role of installation, fixation and protection for the conductive strips, grounding strips and assembly body. Through the mounting holes, it is convenient to install the entire socket on the wall. The ground hole is used to connect the ground wire.

Preferably, the wire connecting device comprises connection bolts arranged on the socket protection shell, and the overload protection device is arranged between one of the conductive strips and its matching connecting bolt, the remaining conductive strips are fixedly connected with its matching connecting bolts, and the socket protective shell is provided with a wire mounting hole matching a position of the connecting bolt, and the wire mounting hole is arranged on a side of the connecting bolt. The electric wire of the power supply is installed in the wire mounting hole and is in contact with the connecting bolt, and the conduction with the conductive strip is realized through the connecting bolt. By arranging an overload protection device between one of the conductive strips and the connecting bolt, the internal structure of the socket is simplified and the internal space is saved while meeting the overload protection requirements.

Preferably, the overload protection device comprises an assembly body, a side of the socket protective shell close to the socket panel is provided with an assembly mounting groove matching the assembly body, the assembly body is arranged in the assembly mounting groove, wherein a deformation piece is arranged inside the assembly body, a first pin and a second pin are arranged on the assembly body, one end of the first pin is arranged outside the assembly body and fixed on one of the conductive strips, and the other end of the first pin is arranged inside the assembly body and is located on a side of the deformation piece, and one end of the second pin is arranged inside the assembly body and is fixedly connected to the deformation piece, the other end of the second pin is arranged outside the assembly body and fixed on the connecting bolt matching the conductive strip. During normal operation, the deformation piece is in contact with the other end of the first pin, and the circuit is turned on; when overload occurs, the deformation piece is heated and deformed, automatically separated from the first pin, and the circuit is disconnected to achieve the purpose of overload protection.

Preferably, the shape of the deformation piece is E-shape, the length of the inner side of the deformation piece is less than the length of the outer side of the deformation piece, the top of the inner side of the deformation piece is fixed with a contact matching the other end of the first pin. The distance between the two outer sides of the deformation piece gradually decreases from the bottom to the top, and the tops of the two outer sides of the deformation piece are both provided with flanging toward inside. When the deformation piece is deformed by an external force, its inner side will automatically convex or concave (at this time, the bottom side will automatically concave or convex in the opposite direction). Therefore, the connection or separation of the contact and the other end of the first pin is realized, thereby realizing the connection and disconnection of the circuit. The structure is simple, the response is fast and sensitive, and the control is very convenient.

Preferably, the socket protective shell is provided with threaded holes matching the connecting bolts, wherein the conductive strips and the first pin are respectively provided with a bolt mounting hole matching the connecting bolt. The connecting bolt is arranged in the threaded hole and penetrates through the bolt mounting hole, so as to realize the connection with the conductive strip and the first pin respectively. This connection method is simple and convenient, easy to install and remove.

Preferably, a reset button is arranged inside the assembly body, and one end of the reset button penetrates a surface of the assembly body and a surface of the socket panel in turn, so as to be placed in the external space and slidably connected with the assembly body and the socket panel, and the other end of the reset button is fixed with clamping seat matching the deformation piece, and the deformation piece is arranged on the clamping seat. When overloaded, the deformation piece is deformed by the force, so that the circuit is disconnected, and the reset button is also pushed out due to the deformation of the deformation piece. When the overload phenomenon is resolved, the user only needs to press the reset button, the deformation piece can be restored to the original state under the force of the reset button, and the circuit can be reconnected. The structure is simple and the control is convenient.

The beneficial effects of the invention are as follows: the structure is simple, the processing and installation are convenient, and the space is saved; the overload protection function is provided, the occurrence of fire is effectively prevented, and the fire safety is ensured; the safety is high; the structural stability is good; the socket can be easily installed on the wall.

### BRIEF DESCRIPTION OF DRAWINGS

FIG. 1 is the schematic diagram of the structure of the present application;

FIG. 2 is the front view of FIG. 1;

FIG. 3 is the top view of FIG. 1;

FIG. 4 is the sectional view at A-A place in FIG. 2;

FIG. 5 is the sectional view at B-B place in FIG. 2;

FIG. 6 is the sectional view at C-C place in FIG. 3;

FIG. 7 is a schematic structural diagram of a conductive strip;

FIG. 8 is a schematic structural diagram of a grounding strip;

FIG. 9 is the structural diagram of the assembly body;

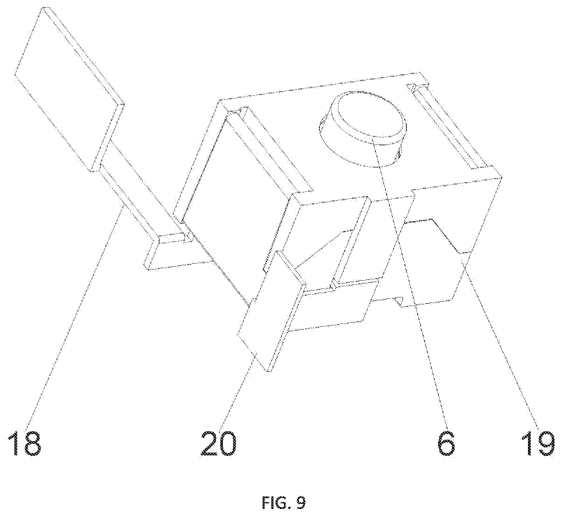

FIG. 10 is the top view of FIG. 9;

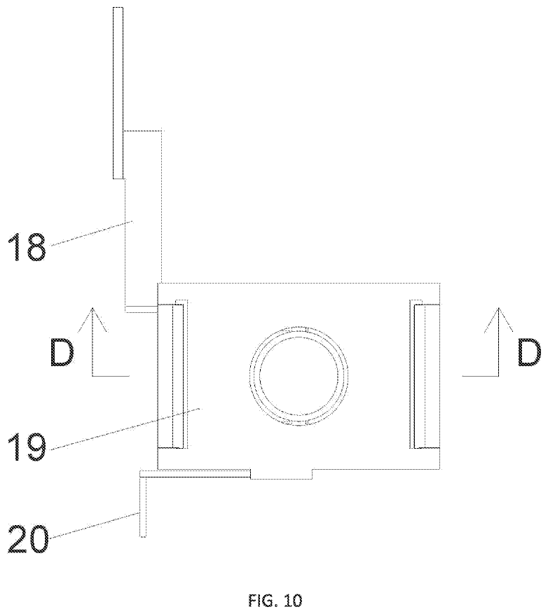

FIG. 11 is a sectional view at D-D in FIG. 10;

FIG. 12 is a schematic structural diagram of the deformation piece.

### REFERENCE SIGNS

1. Socket body, 2. Plug interface, 3. Socket panel, 4. Second jack, 5. First jack, 6. Reset button, 7. Socket protective shell, 8. First pin seat, 9. Conductive strip, 10. Flanging, 11. Grounding strip, 12. Grounding strip through hole, 14. Mounting Plate, 15. Fixing Block, 16. Connecting bolt, 17. Wire Mounting Hole, 18. Second pin, 19. Assembly body, 20. First Pin, 21. Conductive strip mounting slot, 22. Assembly mounting slot, 23. Grounding strip mounting slot, 24. Bolt mounting hole, 25. L-shaped block, 26. Bolt mounting hole, 27. Wiring hole, 28. Deformation sheet, 29. Clamping seat.

### DETAILED DESCRIPTION

The present application will be further described below with reference to the accompanying drawings and specific embodiments.

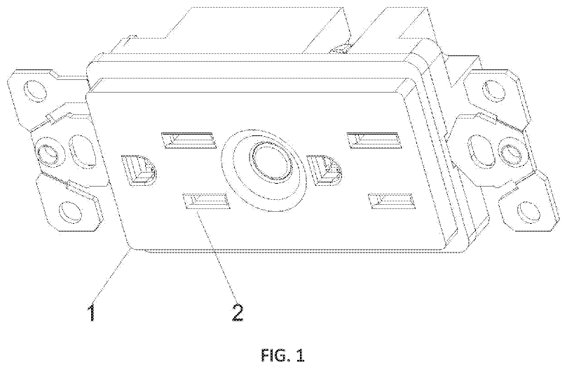

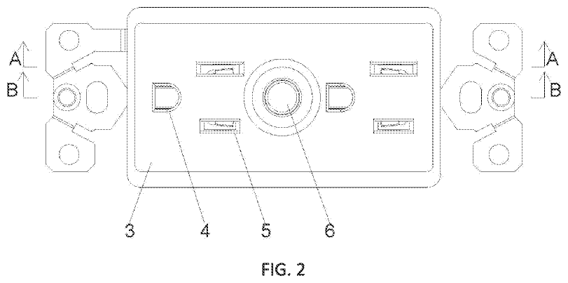

In the embodiment described in FIGS. 1 and 2, an overload protection wall socket, comprising: a socket body 1, a plug interface 2 is provided on the socket body 1, and the plug interface 2 comprises a plurality of first jacks 5 located on surface of the socket body 1, wherein conductive strips 9 matching the first jack 5 are arranged inside the socket body 1, and the conductive strip 9 is provided with a first pin seat 8, the first pin seat 8 is arranged at opening of the first jack 5, and a wire connecting device matching the conductive strip 9 is arranged on the socket body 1, wherein the wire connecting device and the conductive strip 9 are connected through an overload protection device.

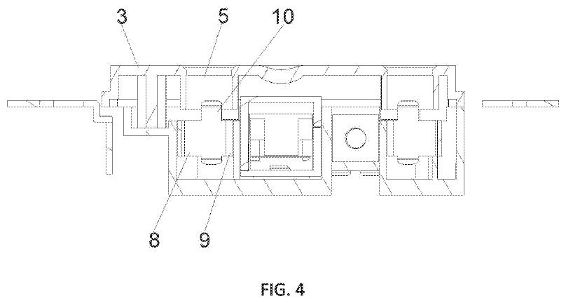

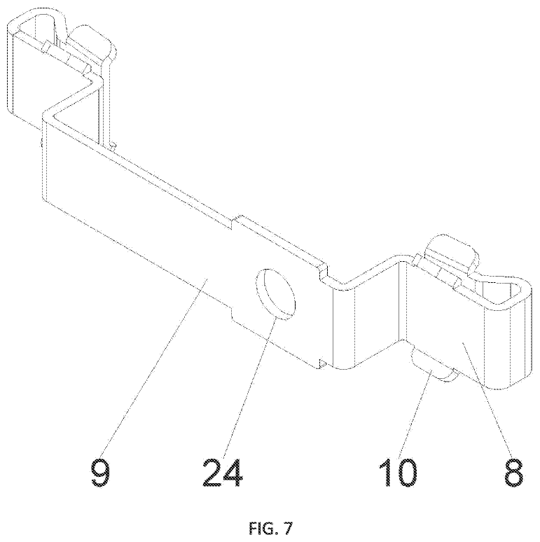

As shown in FIG. 4 and FIG. 7, a cross-sectional shape of the first pin seat 8 is U-shaped, and the first pin seat 8 is fixedly connected to the conductive strip 9, two side legs of the first pin seat 8 are respectively provided with a flanging 10, one side of the flanging 10 is fixed on the side leg of the first pin seat 8 and a chamfer is formed therebetween, the other side of the flanging 10 is placed in the first jack 5, the two flanging 10 are respectively in contact with inner side walls on opposite sides of the first jack 5, and distance between the two flanging 10 gradually increases from one side to the other.

As shown in FIG. 7, the conductive strip 9 is fixedly connected with top of one of the side legs of the first pin seat 8, and the flanging 10 is fixed on side wall of the side leg of the first pin seat 8.

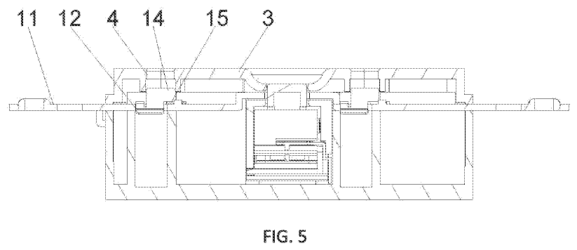

As shown in FIG. 5, the plug interface 2 further comprises a second jacks 4 located on the surface of the socket body 1, the second jack 4 is arranged on one side of the first jack 5, grounding strips 11 matching the second jacks 4 are arranged inside the socket body 1, the grounding strip 11 is provided with a second pin seat, the second pin seat is arranged at opening of the second jack 4.

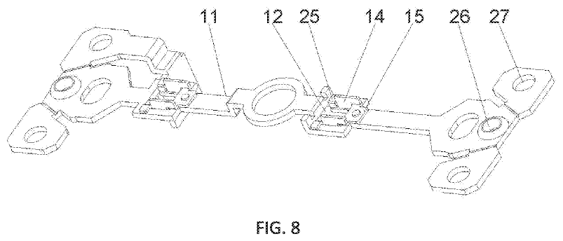

As shown in FIG. 5 and FIG. 8, the second pin seat comprises a fixing block 15 fixed on the grounding strip 11, and mounting plates 14 are fixed on both ends of the fixing block 15, a front side of the mounting plate 14 is arranged in the second jack 4, and the two mounting plates 14 are respectively in contact with inner side walls on opposite sides of the second jack 4, the grounding strip 11 is provided with a grounding strip through hole 12, a rear side of the mounting plate 14 is arranged in the grounding strip through hole 12, and the two mounting plates 14 are respectively in contact with inner side walls on opposite sides of the grounding strip through hole 12, the fixing block 15 is fixed on the left side of the mounting plate 14, the right side of the mounting plate 14 is provided with an L-shaped block 25, one of the sides of the L-shaped block 25 is fixed on the right side of the mounting plate 14, the L-shaped block 25 is arranged at an opening of the ground bar through hole 12 facing the side of the second jack 4.

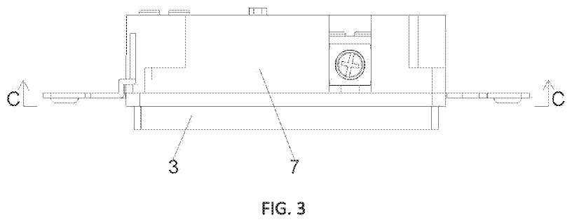

As shown in FIGS. 1 to 3, the socket body 1 comprises a socket panel 3, the first jack 5 and the second jack 4 are arranged on the socket panel 3, a socket protective shell 7 is arranged on the socket panel 3, and a side of the socket protective shell 7 close to the socket panel 3 is provided with conductive strip mounting slots 21 matching the conductive strips 9, grounding strip mounting slots 23 matching the grounding strips 11, wherein the conductive strip 9 and the grounding strip 11 are respectively arranged in the conductive strip mounting slot 21 and the grounding strip mounting slot 23, the grounding strip 11 penetrates the grounding strip mounting slot 23 and is placed outside the socket protective shell 7, the grounding strip 11 is provided with a mounting hole 26 and a wiring hole 27, the mounting hole 26 and the wiring hole 27 are arranged outside the socket protective shell 7.

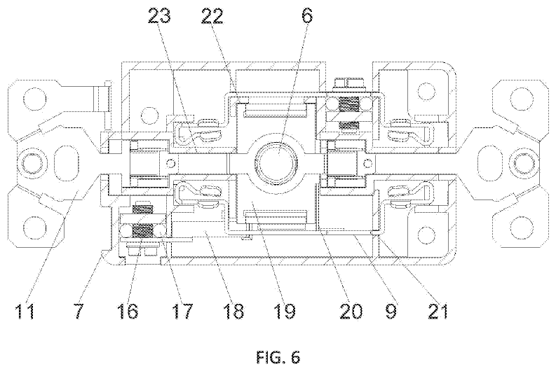

As shown in FIG. 6, the wire connecting device comprises connection bolts 16 arranged on the socket protection shell 7, and the overload protection device is arranged between one of the conductive strips 9 and its matching connecting bolt 16, the remaining conductive strips 9 are fixedly connected with its matching connecting bolts 16, and the socket protective shell 7 is provided with a wire mounting hole 17 matching a position of the connecting bolt 16, and the wire mounting hole 17 is arranged on a side of the connecting bolt 16.

As shown in FIG. 6, the overload protection device comprises an assembly body 19, a side of the socket protective shell 7 close to the socket panel 3 is provided with an assembly mounting groove 22 matching the assembly body 19, the assembly body 19 is arranged in the assembly mounting groove 22, wherein a deformation piece 28 is arranged inside the assembly body 19, a first pin 20 and a second pin 18 are arranged on the assembly body 19, one end of the first pin 20 is arranged outside the assembly body 19 and fixed on one of the conductive strips 9, and the other end of the first pin 20 is arranged inside the assembly body 19 and is located on a side of the deformation piece 28, and one end of the second pin 18 is arranged inside the assembly body 19 and is fixedly connected to the deformation piece 28, the other end of the second pin 18 is arranged outside the assembly body 19 and fixed on the connecting bolt 16 matching the conductive strip 9.

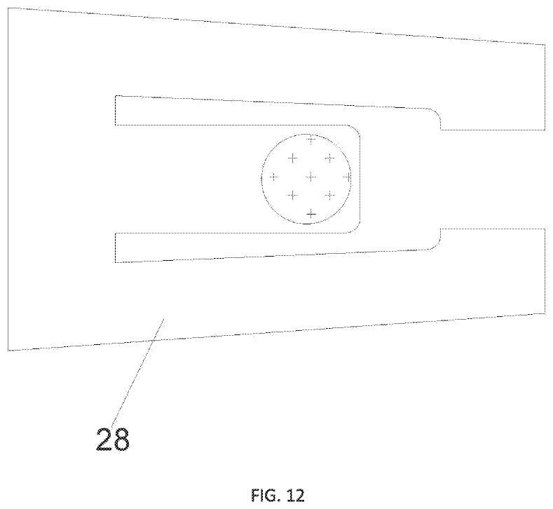

As shown in FIG. 12, the shape of the deformation piece 28 is E-shape, the length of the inner side of the deformation piece 28 is less than the length of the outer side of the deformation piece 28, the top of the inner side of the deformation piece 28 is fixed with a contact matching the other end of the first pin 20. The distance between the two outer sides of the deformation piece 28 gradually decreases from the bottom to the top, and the tops of the two outer sides of the deformation piece 28 are both provided with flanging toward inside.

As shown in FIG. 6 and FIG. 7, the socket protective shell 7 is provided with threaded holes matching the connecting bolts 16, wherein the conductive strips 9 and the first pin 20 are respectively provided with a bolt mounting hole 24 matching the connecting bolt 16.

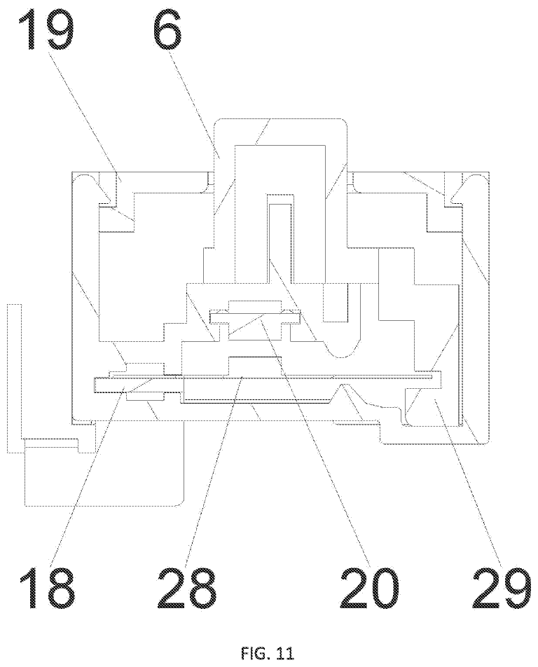

As shown in FIG. 11, a reset button 6 is arranged inside the assembly body 19, and one end of the reset button 6 penetrates a surface of the assembly body 19 and a surface of the socket panel 3 in turn, so as to be placed in the external space and slidably connected with the assembly body and the socket panel, and the other end of the reset button (6) is fixed with clamping seat 29 matching the deformation piece 28, and the deformation piece is arranged on the clamping seat 29.

The present invention is an American standard three-hole socket (two conductive strips 9 are respectively connected to the power live wire and power supply neutral wire, and a grounding strip 11 is connected to the grounding wire), and the number of plug interfaces 2 is two (the number of pin sockets—8 on the conductive strip 9 and the number of pin sockets 2 on the grounding strip 11 is the same as that of the plug interface 2).

During installation, the live wire of the power supply and the neutral wire of the power supply are respectively installed in the two wire mounting holes 17 and are in contact with the corresponding connecting bolts 16 (the heads of the connecting bolts 16 are insulators and are placed outside the socket protective shell 7; The rod portion of the connecting bolt 16 is a conductor, placed inside the socket protective shell 7 and in contact with the power wire), and the wiring hole 27 on the grounding strip 11 is connected to the grounding wire; The load plug is inserted at the plug interface 2, the pin inserted into the first jack 5 is clamped and fixed by the two side legs of the pin seat 1 8 and is in contact with the conductive bar 9, and the pin inserted into the jack 2 4 is in contact with the grounding strip 11.

The assembly body 19 can be installed between any one of the conductive strips 9 and its corresponding connecting bolts 16.

Working principle: When the load is working normally, the contact on the deformation piece 28 is in contact with the other end of the first pin 20. When an overload condition occurs, the deformation piece 28 is heated and deformed, and the contact on it is automatically separated from the first pin 20, and the circuit is disconnected. At the same time, the reset button 6 is also pushed out due to the deformation of the deformation piece 28. When the overload phenomenon is resolved, the user only needs to press the reset button 6, and the deformable piece 28 can be restored to its original state under the force of the reset button 6, and the circuit can be reconnected.

1. An overload protection wall socket, comprising: a socket body (1), a plug interface (2) is provided on the socket body (1), and the plug interface (2) comprises a plurality of first jacks (5) located on surface of the socket body (1), wherein conductive strips (9) matching the first jack (5) are arranged inside the socket body (1), and the conductive strip (9) is provided with a first pin seat (8), the first pin seat (8) is arranged at opening of the first jack (5), and a wire connecting device matching the conductive strip (9) is arranged on the socket body (1), wherein the wire connecting device and the conductive strip (9) are connected through an overload protection device.

2. The overload protection wall socket according to claim 1, wherein a cross-sectional shape of the first pin seat (8) is U-shaped, and the first pin seat (8) is fixedly connected to the conductive strip (9), two side legs of the first pin seat (8) are respectively provided with a flanging (10), one side of the flanging (10) is fixed on the side leg of the first pin seat (8) and a chamfer is formed therebetween, the other side of the flanging (10) is placed in the first jack (5), the two flanging (10) are respectively in contact with inner side walls on opposite sides of the first jack (5), and distance between the two flanging (10) gradually increases from one side to the other.

3. The overload protection wall socket according to claim 2, wherein the conductive strip (9) is fixedly connected with top of one of the side legs of the first pin seat (8), and the flanging (10) is fixed on side wall of the side leg of the first pin seat (8).

4. The overload protection wall socket according to claim 1, wherein the plug interface (2) further comprises a second jacks (4) located on the surface of the socket body (1), the second jack (4) is arranged on one side of the first jack (5), grounding strips (11) matching the second jacks (4) are arranged inside the socket body (1), the grounding strip (11) is provided with a second pin seat, the second pin seat is arranged at opening of the second jack (4).

5. The overload protection wall socket according to claim 4, wherein the second pin seat comprises a fixing block (15) fixed on the grounding strip (11), and mounting plates (14) are fixed on both ends of the fixing block (15), a front side of the mounting plate (14) is arranged in the second jack (4), and the two mounting plates (14) are respectively in contact with inner side walls on opposite sides of the second jack (4), the grounding strip (11) is provided with a grounding strip through hole (12), a rear side of the mounting plate (14) is arranged in the grounding strip through hole (12), and the two mounting plates (14) are respectively in contact with inner side walls on opposite sides of the grounding strip through hole (12), the fixing block (15) is fixed on the left side of the mounting plate (14), the right side of the mounting plate (14) is provided with an L-shaped block (25), one of the sides of the L-shaped block (25) is fixed on the right side of the mounting plate (14), the L-shaped block (25) is arranged at an opening of the ground bar through hole (12) facing the side of the second jack (4).

6. The overload protection wall socket according to claim 4, wherein the socket body (1) comprises a socket panel (3), the first jack (5) and the second jack (4) are arranged on the socket panel (3), a socket protective shell (7) is arranged on the socket panel (3), and a side of the socket protective shell (7) close to the socket panel (3) is provided with conductive strip mounting slots (21) matching the conductive strips (9), grounding strip mounting slots (23) matching the grounding strips (11), wherein the conductive strip (9) and the grounding strip (11) are respectively arranged in the conductive strip mounting slot (21) and the grounding strip mounting slot (23), the grounding strip (11) penetrates the grounding strip mounting slot (23) and is placed outside the socket protective shell (7), the grounding strip (11) is provided with a mounting hole (26) and a wiring hole (27), the mounting hole (26) and the wiring hole (27) are arranged outside the socket protective shell (7).

7. The overload protection wall socket according to claim 6, wherein the wire connecting device comprises connection bolts (16) arranged on the socket protection shell (7), and the overload protection device is arranged between one of the conductive strips (9) and its matching connecting bolt (16), the remaining conductive strips (9) are fixedly connected with its matching connecting bolts (16), and the socket protective shell (7) is provided with a wire mounting hole (17) matching a position of the connecting bolt (16), and the wire mounting hole (17) is arranged on a side of the connecting bolt (16).

8. The overload protection wall socket according to claim 7, wherein the overload protection device comprises an assembly body (19), a side of the socket protective shell (7) close to the socket panel (3) is provided with an assembly mounting groove (22) matching the assembly body (19), the assembly body (19) is arranged in the assembly mounting groove (22), wherein a deformation piece (28) is arranged inside the assembly body (19), a first pin (20) and a second pin (18) are arranged on the assembly body (19), one end of the first pin (20) is arranged outside the assembly body (19) and fixed on one of the conductive strips (9), and the other end of the first pin (20) is arranged inside the assembly body (19) and is located on a side of the deformation piece (28), and one end of the second pin (18) is arranged inside the assembly body (19) and is fixedly connected to the deformation piece (28), the other end of the second pin (18) is arranged outside the assembly body (19) and fixed on the connecting bolt (16) matching the conductive strip (9).

9. The overload protection wall socket according to claim 7, wherein the socket protective shell (7) is provided with threaded holes matching the connecting bolts (16), wherein the conductive strips (9) and the first pin (20) are respectively provided with a bolt mounting hole (24) matching the connecting bolt (16).

10. The overload protection wall socket according to claim 8, wherein a reset button (6) is arranged inside the assembly body (19), and one end of the reset button (6) penetrates a surface of the assembly body (19) and a surface of the socket panel (3) in turn, so as to be placed in the external space and slidably connected with the assembly body and the socket panel, and the other end of the reset button (6) is fixed with clamping seat (29) matching the deformation piece (28), and the deformation piece is arranged on the clamping seat (29). arranged in the assembly mounting groove (22), wherein a deformation piece (28) is arranged inside the assembly body (19), a first pin (20) and a second pin (18) are arranged on the assembly body (19), one end of the first pin (20) is arranged outside the assembly body (19) and fixed on one of the conductive strips (9), and the other end of the first pin (20) is arranged inside the assembly body (19) and is located on a side of the deformation piece (28), and one end of the second pin (18) is arranged inside the assembly body (19) and is fixedly connected to the deformation piece (28), the other end of the second pin (18) is arranged outside the assembly body (19) and fixed on the connecting bolt (16) matching the conductive strip (9).

9. The overload protection wall socket according to claim 7, wherein the socket protective shell (7) is provided with threaded holes matching the connecting bolts (16), wherein the conductive strips (9) and the first pin (20) are respectively provided with a bolt mounting hole (24) matching the connecting bolt (16).

10. The overload protection wall socket according to claim 8, wherein a reset button (6) is arranged inside the assembly body (19), and one end of the reset button (6) penetrates a surface of the assembly body (19) and a surface of the socket panel (3) in turn, so as to be placed in the external space and slidably connected with the assembly body and the socket panel, and the other end of the reset button (6) is fixed with clamping seat (29) matching the deformation piece (28), and the deformation piece is arranged on the clamping seat (29).
